(19) United States
(12) Patent Application Publication
(10) Pub. No.: US 2010/0258746 A1
(43) Pub. Date: Oct. 14, 2010

(54) Massive parallel generation of nonclassical photons via polaritonic superfluid to mott- insulator quantum phase transition

(76) Inventors: Yun-Chung Na, Palo Alto, CA (US); Yoshihisa Yamamoto, Stanford, CA (US)

Correspondence Address: LUMEN PATENT FIRM, 350 Cambridge Avenue, Suite 100, PALO ALTO, CA, 94306, US

(21) Appl. No.: 12/798,751

(22) Filed: Apr. 8, 2010

Related U.S. Application Data
(60) Provisional application No. 61/167,588, filed on Apr. 8, 2009.

(51) Int. Cl. G21G 7/00

(52) U.S. Cl. 250/493.1; 977/759

(57) ABSTRACT

Deterministic generation of nonclassical photons by producing a dilute gas of exciton-polaritons in a solid-state microcavity that includes a periodic array of potential well traps. A photon-exciton frequency detuning is modulated in the microcavity to produce a polaritonic quantum phase transition from a superfluid state to a Mott-insulator state. The nonclassical photons are then generated simultaneously by radiative decay of exciton-polaritons in the microcavity. The nonclassical photons may be indistinguishable single photons, in which case the dilute gas of exciton-polaritons is produced such that on to average there is one polariton per potential well trap. Alternatively, the generated nonclassical photons may be polarization-entangled photon pairs, in which case the dilute gas of exciton-polaritons is produced such that on average there are two polaritons per potential well trap.

### CROSS-REFERENCE TO RELATED APPLICATIONS

This application claims priority from U.S. Provisional Patent Application 61/167,588 filed Apr. 8, 2009, which is incorporated herein by reference.

### FIELD OF THE INVENTION

The present invention relates generally to devices and techniques for generating nonclassical photons. More specifically, it relates to methods and devices for generating indistinguishable single photons or polarization-entangled photon pairs.

### BACKGROUND OF THE INVENTION

Quantum information technologies such as quantum computation, cryptography, and metrology rely on the use of single and/or entangled photon sources. In addition, generation of indistinguishable single photons is essential for scalable quantum information processing. Existing devices for single photon generation include p-i-n heterojunction single-photon turnstile device and semiconductor quantum dots in a microdisc microcavity. However, current approaches where single photons are generated by the radiative decay of spatially independent emitters pumped by incoherent optical excitation, only up to two independent single-photon sources can be prepared. A collective generation of many indistinguishable single photons simultaneously still remains out of reach. Moreover, existing techniques for generating single and/or entangled photons are expensive and inefficient where usually at most one photon/photon-pair can be triggered in every cycle.

### SUMMARY OF THE INVENTION

Techniques of the present invention can generate many indistinguishable single photons, or polarization-entangled photon pairs, in parallel deterministically. The techniques are useful for applications in various areas including scalable quantum computation and communication, as well as photonic quantum information processing. The technique largely reduces the expensive building blocks such as quantum memory and repeater, and therefore boosts the development of quantum information processing. A variety of other applications, such as photon number eigenstate interferometer, precision optical metrology, and subwavelength quantum lithography, can also benefit from the techniques of the invention.

Massive parallel generation of nonclassical light is deterministically produced according to techniques of the present invention by using a polaritonic quantum phase transition from a superfluid state to Mott-insulator state. The techniques can massively generate single/entangled photons in parallel on demand. More importantly, the technique is fault-tolerant and therefore serves as a practical scheme to be realized. In one embodiment, a device realizing the technique is based on a periodically modulated planar semiconductor microcavity QED system with top electrode gate controls and optical pumping. The principles of the invention, however, can be realized in various other types of microcavities such as, for example, a photonic crystal microcavity.

In one aspect, a method is provided for deterministic generation of nonclassical photons. According to the method, a dilute gas of exciton-polaritons is produced in a solid-state microcavity that includes a periodic array of potential well traps. The dilute gas of exciton-polaritons may be produced, for example, by coupling the microcavity with an external laser pulse that has a predetermined amplitude and width. Alternatively, electrical pumping may be used. The microcavity may be realized, for example, as a planar microcavity or a photonic crystal microcavity. The planar microcavity may be realized, for example, as a single quantum well, or multiple quantum wells, embedded in a half-wavelength optical cavity layer sandwiched between upper and lower distributed Bragg reflectors. The optical cavity layer may be spatially modulated in thickness to produce photon traps. A photon-exciton frequency detuning is modulated in the microcavity to produce a polaritonic quantum phase transition from a superfluid state to a Mott-insulator state. The photon-exciton frequency detuning may be modulated, for example, by applying a switched vertical electric field to the microcavity to perform an adiabatic quantum phase transition through the quantum-confined Stark effect. The nonclassical photons are then generated simultaneously by radiative decay of exciton-polaritons in the microcavity. The nonclassical photons may be indistinguishable single photons, in which case the dilute gas of exciton-polaritons is produced such that on average there is one polariton per potential well trap. Alternatively, the generated nonclassical photons may be polarization-entangled photon pairs, in which case the dilute gas of exciton-polaritons is produced such that on average there are two polaritons per potential well trap.

### BRIEF DESCRIPTION OF THE DRAWINGS

FIG. 1 is a schematic diagram of a device for massive parallel generation of indistinguishable single photons according to an embodiment of the present invention.

FIG. 2 is a graph of the ratio of polariton interaction energy to polariton tunneling energy as a function of photon-exciton frequency detuning. Two photon tunneling energies, 2 GHz and 20 GHz, are examined; for t=20 GHz, it corresponds to ˜2 μm of inter-cavity distance assuming a Gaussian-like cavity field.

FIGS. 3A-D are graphs illustrating device operation procedures and dynamics as a function of time according to an embodiment of the invention. In FIGS. 3A-B, the solid line corresponds to the electrical switch pulse. In FIGS. 3C-D, the lines correspond to the average LP number, average photon number, and LP second-order coherence.

FIG. 4 is a graph of the far-field optical interference visibility and the single photon indistinguishability as a function of time according to an embodiment of the present invention. Only odd numbered cavities are taken into calculations. The slight oscillations in both parameters indicate the weak non-adiabaticity due to the used of a moderately fast 8 switching.

FIG. 5 is a phase diagram of the BHM according to an embodiment of the present invention. The system is first pumped by a linearly-polarized (π) external laser at a large J/U to <N>=2, and then followed by an adiabatic δ switching to cross the SF-MI boundary. Subsequent selective switching triggers the generation of polarization-entangled photon pairs that are circularly-polarized (a).

FIG. 6 is a schematic diagram of a photonic crystal microcavity device according to an embodiment of the invention.

FIG. 7 is an outline of the main steps for generating nonclassical light according to an embodiment of the present invention.

### DETAILED DESCRIPTION

### Introduction and Definitions

The present invention relates to techniques for the generation of nonclassical photons of light. A state of light is defined as nonclassical when it cannot be properly described using classical electromagnetism, i.e., it requires a quantum mechanical description of light, e.g., using quantum optics. Many existing and emerging technologies rely on the unique properties of nonclassical light and require special solid state devices to generate nonclassical photons. Such devices must be designed using a quantum mechanical treatment of materials. One such class of devices are optical microcavities, which are most commonly realized as planar microcavities, but which may also be realized in other forms, such as photonic crystal microcavities. Microcavities have many applications in optoelectronics and have also been used to create single photon emitting devices.

A planar microcavity is an optical device composed of an optical medium, or cavity layer, sandwiched between two optical reflectors. Because the thickness of the cavity layer is typically just a few hundreds of nanometers, the microcavity exhibits quantum mechanical effects not present in larger classical optical cavities.

A photonic crystal microcavity is created by altering periodic optical nanostructures in a photonic crystal. Photonic crystals contain periodic internal regions of high and low dielectric constant that give rise to optical effects such as high-reflecting omni-directional mirrors and low-loss-waveguiding which may be used to create a microcavity structure in the crystal.

The design of solid state photonic devices often involves an understanding of quasiparticles such as exitons and polaritons. A quasiparticle is a phenomenon in solid state materials that behaves as a single free particle. The most well known quasiparticles are phonons and particle-hole pairs. An exciton is a bound state of an electron and a hole. This excitation in a lattice can propagate in a particle-like way through the material without the transfer of charge. Excitons can be created when a photon is absorbed by a material, causing the creation of an electron-hole pair. The recombination of the electron and hole corresponds to the annihilation of the exciton. Exciton-polaritons (referred to herein simply as polaritons) are a type of quasiparticle that results from strong coupling of photons and exitons. Polaritons are the normal modes of a strongly coupled photon-exciton system.

Quasiparticle systems can exist in different states and undergo phase transitions, including quantum phase transitions. A quantum phase transition (QPT) is a phase transition between different quantum phases of a system. In contrast to classical phase transitions which are thermodynamic in nature, quantum phase transitions occur at absolute zero temperature by changing a physical parameter (such as magnetic field or pressure) to produce a change in the ground state of the system. The techniques of the present invention involve a particular QPT in an exciton-polariton system between a polariton superfluid state and a Mott-insulator state.

Embodiments of the present invention provide techniques and devices to generate indistinguishable single photons or entangled photon pairs in a massive parallel fashion. More importantly, the devices can be deterministically controlled and do not suffer from effects of fabrication disorder. A basic idea of the techniques is to load a dilute gas of exciton-polaritons in a periodic potential traps, and drive the system across the superfluid (SF) to Mott-insulator (MI) quantum phase transition (QPT) by modulating the photon-exciton frequency detuning. The generation of indistinguishable single photons can then be triggered independently in the MI phase by the radiative decay of exciton-polaritons. As a consequence, massive numbers of indistinguishable single photons can be produced in parallel. Such a polaritonic QPT from a SF to MI state may be realized in a variety of solid-state systems, such as a cavity array containing four-level atomic ensembles in an electromagnetic induced transparency (EIT) configuration, single-atom cavity QED array, and excitonic cavity QED array.

### Device Structure

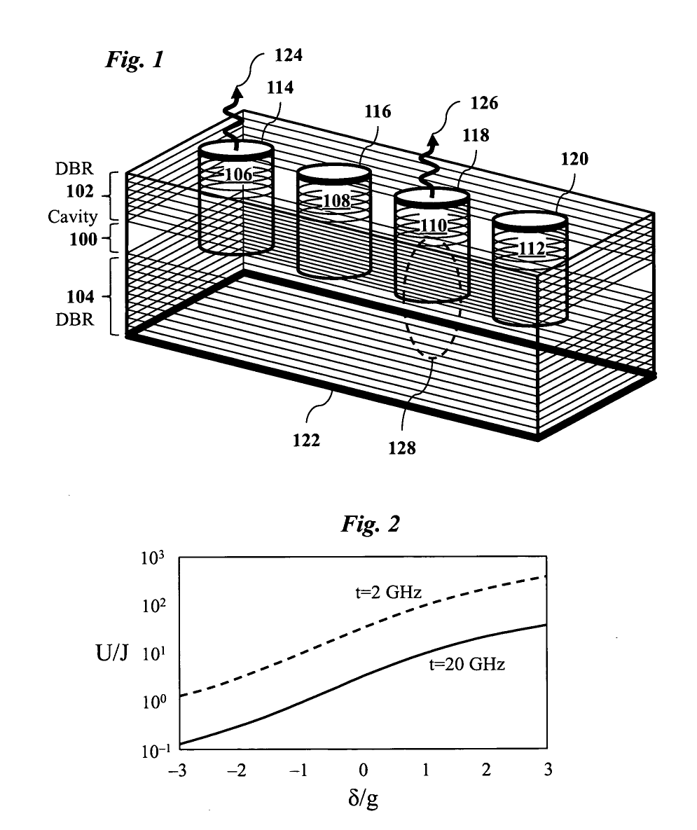

Although a specific device will now be described for purposes of illustration, the same principles can be applied to different variations of materials, types of cavities, and control of detuning. FIG. 1 shows a schematic diagram of a device according to an embodiment of the invention. A single GaAs quantum well (QW) is embedded in a half-wavelength AlₓGa₁₋ₓAs optical cavity layer 100, which is sandwiched in between upper distributed-bragg-reflector (DBR) 102 and lower DBR 104. The thickness of optical cavity layer 100 is spatially modulated by etching small mesas that serve as photon trapping centers 106, 108, 110, 112, which can be treated as single-mode cavities. A polariton may be trapped, for example, in region 128. These three-dimensionally confined microcavities can be fabricated using techniques known in the art. Preferably, devices contain arrays of such traps to provide simultaneous generation of large numbers of photons. Semi-transparent metal gates 114, 116, 118, 120 are fabricated on top of the traps 106, 108, 110, 112, respectively, and are used together with back contact 122 fabricated at the bottom of DBR 104 to apply a vertical electric field so that the photon-exciton frequency detuning can be controlled by quantum-confined Stark effect (QCSE). The lower DBR 104 is made thicker than the upper DBR 102 to enforce single-side cavity emission of photons such as photons 124 and 126. The modulated planar microcavities inherit circular symmetry and are suitable for coupling to down-stream fiber-optics with high collection efficiency. The output single photon frequency is tuned away from that of the input coherent laser so that a clean signal can be spectrally selected.

Photons and excitons in this system are strongly coupled to each other, and their normal modes are defined as polaritons. Cavity photons are laterally trapped by selection of the local cavity layer thickness. QW exciton is trapped by applying a vertical electric field. QCSE provides additional control of the system. The system has a very large nonlinearity due to electron-electron/hole-hole exchange and phase space filling effect. The dynamics of such an array of exciton-polariton traps can be described by the Bose-Hubbard model (BHM) with a system-reservoir coupling, which will be discussed in depth below.

### Theoretical Description

The Hamiltonian of the system of the device is given by

$$H = {\sum }_{c = a , b} \int d r {Ψ}_{c}^{†} ( r ) ( \frac{- {∇}^{2}}{2 {m}_{c}} + {V}_{c} ( r ) ) {Ψ}_{c} ( r ) + {g}^{′} \int d r {Ψ}_{a}^{{ }^{†}} ( r ) {Ψ}_{b} ( r ) + H . c . + \frac{{u}^{′}}{2} \int d r {Ψ}_{b}^{†} ( r ) {Ψ}_{b}^{†} ( r ) {Ψ}_{b} ( r ) {Ψ}_{b} ( r ) - Δ {g}^{′} \int d r {Ψ}_{b}^{†} ( r ) {Ψ}_{a}^{†} ( r ) {Ψ}_{b} ( r ) {Ψ}_{b} ( r ) + H . c + \int d {rf}^{′} ( r , t ) {e}^{- i vt} {Ψ}_{a}^{†} ( r ) + H . c . \qquad ( 1 )$$

where the field operators Ψₐ and Ψ_{b} refer to cavity photon and QW exciton, respectively. The first term in Eq. 1 represents the free Hamiltonians of trapped photons and excitons. The second through fifth terms correspond to photon-exciton coupling, exciton-exciton repulsion, reduction of excitonic dipole moment, and external laser coupled to cavity mode, respectively. Since the effective mass of a QW exciton is much larger than that of a cavity photon, it is appropriate to define a single-mode exciton operator b, that features the same wave function as of single-mode photon operator aᵢ. By doing so, Eq. 1 can be rewritten as

$$H = {ω}_{a} {\sum }_{i} {a}_{i}^{†} {a}_{i} + t {\sum }_{< i j >} {a}_{i}^{†} {a}_{j} + {ω}_{b} {\sum }_{i} {b}_{i}^{†} {b}_{i} + g {\sum }_{i} ( {a}_{i}^{†} {b}_{i} + H . c ) + \frac{u}{2} {\sum }_{i} {b}_{i}^{†} {b}_{i}^{†} {b}_{i} {b}_{i} - Δ g {\sum }_{i} ( {b}_{i}^{†} {a}_{i}^{†} {b}_{i} {b}_{i} + H . c ) + f ( t ) {\sum }_{i} ( {a}_{i}^{†} {e}^{- i vt} + H . c . ) . \qquad ( 2 )$$

where ωₐ and ω_{b} are the site cavity photon and QW exciton energies, t is the photon tunneling energy determined by the overlapping of nearest-neighbor cavity fields, g is the photon-exciton coupling constant, u and Δg are energies that correspond to the exciton-exciton repulsion and the reduction of excitonic dipole moment, and f(t) and v are the external laser amplitude and energy.

Next, we define the upper polariton (UP) and lower polariton (LP) operators qᵢ and pᵢ as a linear superposition of aᵢ and bᵢ with appropriate Hopfield coefficients A and B. Here we define qᵢ=−Baᵢ−Abᵢ and pᵢ=−Aaᵢ+Bbᵢ so that

$$A = \frac{2 g}{\sqrt{{( δ + \sqrt{{δ}^{2} + 4 {g}^{2}} )}^{2} + 4 {g}^{2}}}$$

$$and$$

$$B = \frac{( δ + \sqrt{{δ}^{2} + 4 {g}^{2}} )}{\sqrt{{( δ + \sqrt{{δ}^{2} + 4 {g}^{2}} )}^{2} + 4 {g}^{2}}}$$

are both greater than zero. The variable δ=ωₐ−ω_{b} is the photon-exciton frequency detuning. Note the LPs are photon-like, i.e., A>>B, when δ<0 and |δ|>>g (large red-detuning); they are exciton-like, i.e., B>>A, when δ>0 and |δ|>>g (large blue-detuning). The system master equation for LPs in the rotating frame of the external laser is derived as

$$\frac{d ρ}{d t} = \frac{1}{i} [ \tilde{H} , ρ ] - \frac{Γ}{2} {\sum }_{i} ( ρ {p}_{i}^{†} {p}_{i} + {p}_{i}^{†} {p}_{i} ρ - 2 {p}_{i} ρ {p}_{i}^{†} ) \qquad ( 3 )$$

under rotating wave approximation, where

$$\tilde{H} = - Δ {\sum }_{i} {p}_{i}^{†} {p}_{i} - J {\sum }_{〈 ij 〉} {p}_{i}^{†} {p}_{j} + \frac{U}{2} {\sum }_{i} {p}_{i}^{†} {p}_{i}^{†} {p}_{i} {p}_{i} + F ( t ) {\sum }_{i} ( {p}_{i}^{†} + {p}_{i} ) . \qquad ( 4 )$$

UP dynamics are discarded because the external laser selectively pumps the LPs. The variable Δ is the energy difference between the external laser and the trapped LPs, J is the LP tunneling energy and is equal to tA², and U is the LP-LP interaction energy and is equal to uB⁴+4ΔgB³A. Assuming an infinite potential barrier with area S for photon trapping, u can be calculated by ˜2.2E_{B}·πa_{B}²/S due to fermionic exchange interaction, and Δg can be calculated by ˜4g·πa_{B}²/S due to phase space filling and fermionic exchange interaction. The variables E_{B} and a_{B} are the 1s exciton binding energy and Bohr radius, respectively. Let S=π(λ/2)² where λ=222 nm (the emission wavelength of a 10 nm GaAs QW divided by GaAs refractive index at 4 K), then u and Δg are derived as 200 and 90 μeV, given E_{B}=10 meV, a_{B}=10 nm, and g=2.5 meV. F(t) is equal to f(t)A·Γ is the LP decay rate and is equal to A²Q/ωₐ+B²/τ_{b}. Cavity Q factor equal to 10⁶ and QW exciton lifetime τ_{b} equal to 0.5 ns are used. Note that because the acoustic phonon-polariton scattering time exceeds 1 ns for zero in-plane momentum regime at 4 K, and the polariton-polariton scattering is negligible for LP density smaller than 10⁻², our system decoherence is expected to be limited by the radiative process.

For an ideal 1D system with unit filling, the critical point of BHM calculated by quantum Monte-Carlo simulation is U/J_{c}˜2.04. If we assume the polariton lifetime is long enough compared to all other time scales, this condition of QPT can be reasonably applied in our system. FIG. 2 is a graph of U/J as a function of photon-exciton frequency detuning δ=ωₐ−ω_{b}, given different t values (t=2 GHz and t=20 GHz) that are determined by the inter-cavity distance. It is found that the critical point can be reach by modulating a negative δ (red detuning) into a positive δ (blue detuning), i.e., changing from a photon-like polariton into an exciton-like polariton. This is physically expected, because, an exciton-like polariton features larger U (due to exciton nonlinearity) and at the same time smaller J (due to photon tunneling).

### Device Operation and Properties

Operational characteristics of the device may be characterized by numerical simulations performed by discretizing Eq. 3 in the time domain, where the matrix representations of all operators are constructed. Due to the huge increase of Hilbert space size with cavity number, for simplicity of illustration we choose six one-dimensional coupled cavities with periodic boundary conditions. The sharp SF to MI QPT is smeared in such a finite number of cavities, but suffices to demonstrate the operational principles of the device.

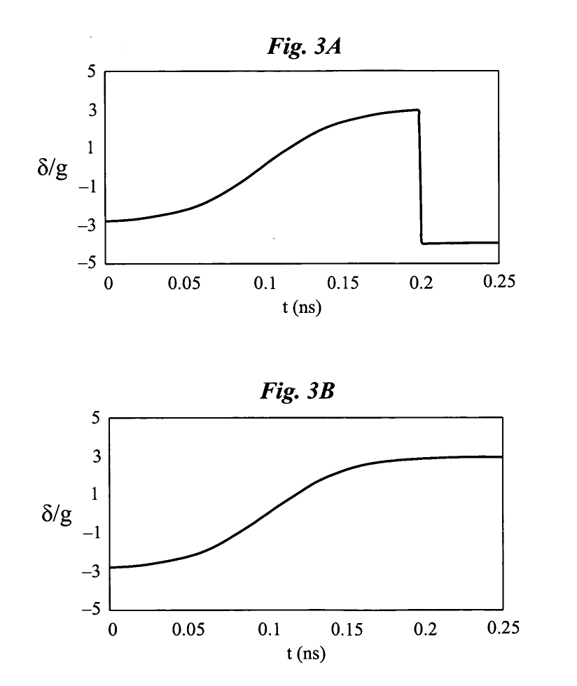

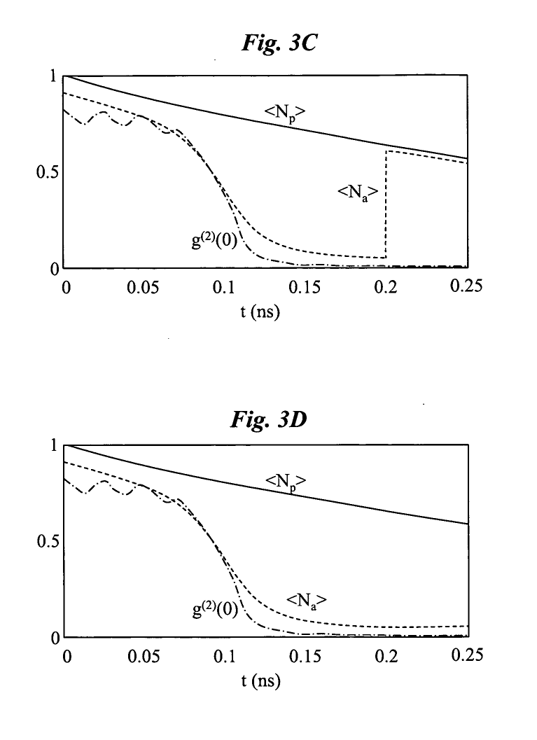

The device operation procedures are shown in FIGS. 3A and 3B for the odd and even numbered cavities, respectively. The system is initially (at 0 ps) prepared in a photon-like SF state where U/J˜0.13, which is realized by a large red photon-exciton frequency detuning δ=−3g and an numerical excitation condition

$$\frac{1}{N !} {( \frac{1}{\sqrt{N}} {\sum }_{i = 1}^{N} {p}_{i}^{†} )}^{n} {{ρ}_{o} ( \frac{1}{\sqrt{N}} {\sum }_{i = 1}^{N} {p}_{i} )}^{n} . \qquad ( 5 )$$

where N is the cavity number, n is the polariton number, and ρₒ is the density matrix of vacuum, respectively. Note that Eq. 5 excites on-average one polariton per cavity that hops randomly in the coupled cavities. Experimentally, this can be achieved by controlling an external laser coupled to the cavity mode with appropriate pulse amplitude and width, because a coherent field excitation can mimic the initialization condition of Eq. 5 in the thermodynamic limit (N>>1). Then, by using QCSE (from 0 to 200 ps), the QW exciton energy is lowered by the applied vertical electric field so that δ is switched from −3g to 4g, i.e., into an exciton-like MI state where U/J˜35. A single LP is localized in each cavity due to the dominance of polariton-polariton interaction over nearest-neighbor tunneling. The shape of electrical switch pulse follows a hyperbolic tangential function with switching speed equal to 10 GHz, which is chosen to perform an adiabatic transition during this time window. Finally, while 8 of the even numbered cavities stay at 4g, δ of the odd numbered cavities are switched rapidly at the speed of 1 THz back to −4g (at 200 ps). Single photon emissions are now triggered from the odd number cavities (the purpose of such a selective switching will be explained shortly). Note that τ_{b} and g are independent of δ because the lifetime and oscillator strength of a QW exciton barely change for the range of vertical electric field used in the above δ switching.

The use of selective switching at 250 ps is motivated by three considerations. First, the quantum efficiency of generating single photons

$$η = \int 〈 {p}_{i}^{†} ( t ) {p}_{i} ( t ) 〉 {A}^{2} ( t ) \frac{Q}{{ω}_{a}} d t \qquad ( 6 )$$

should be maximized so that a polariton decay is mostly directed to the cavity mode. Switching the exciton-like LPs back to the photon-like LPs achieves this goal. Second, if all of the cavities are switched back to a large red detuning regime, rapid tunneling process with J/Γ˜194 readily destroys the deterministic single polariton decay from individual site. Instead, in the present selective switching, only the LPs in the odd numbered cavities are switched back to a large red detuning regime so that the neighboring site energy mismatch effectively cuts off the unwanted tunneling events. Finally, the frequency of the emitted single photons is tuned away from that of the external laser. Using a narrow band-pass frequency filter, clean output signal can be selected out.

The dynamics of the odd and even numbered cavities are shown in FIGS. 3C and 3D, respectively. During the adiabatic δ switching, the normalized zero-delay second-order coherence function g⁽²⁾)(0) starts with ˜0.81 at 0 ps due to injecting 6 photon-like LPs that hop randomly in the coupled cavities, and subsequently drops to ˜0.01 at 200 ps due to localizing 1 exciton-like LP in each cavity. This strongly antibunching behavior indicates the crossing of SF to MI boundary. The effect of selective switching can be seen from the sharp increase of the average photon number <Nₐ> in the odd numbered cavities. The value η of the single photon emissions is ˜79.5%, and can be further maximized by carefully designing the switch pulse shape. The ultimate physical limit of η comes from how large U or J_{c} can be and therefore how fast an adiabatic δ switching may use.

To further understand the system dynamics, we define two parameters: the far-field optical interference visibility

$$\begin{matrix}V ( t ) ≡ \frac{{〈 {n}_{a} ( t ) 〉}_{max} - {〈 {n}_{a} ( t ) 〉}_{min}}{{〈 {n}_{a} ( t ) 〉}_{max} + {〈 {n}_{a} ( t ) 〉}_{min}} \\ where & ( 7 ) \\ {n}_{a} ( t ) = \frac{1}{N} {\sum }_{m , n ∈ Z} {a}_{m}^{†} ( t ) {a}_{n} ( t ) {e}^{i ( m - n ) ϕ} , & ( 8 )\end{matrix}$$

and the single photon indistinguishability

$$\begin{matrix}I ( t ) ≡ 1 - \frac{〈 {c}_{1}^{†} ( t ) {c}_{3}^{†} ( t ) {c}_{3} ( t ) {c}_{1} ( t ) 〉}{〈 {c}_{1}^{†} {c}_{1} ( t ) 〉 〈 {c}_{3}^{†} ( t ) {c}_{3} ( t ) 〉} \\ where & ( 9 ) \\ ( \begin{matrix}{c}_{1} \\ {c}_{3}\end{matrix} ) = \frac{1}{\sqrt{2}} ( \begin{matrix}1 & 1 \\ - 1 & 1\end{matrix} ) ( \begin{matrix}{a}_{1} \\ {a}_{3}\end{matrix} ) . & ( 10 )\end{matrix}$$

The variable φ is the optical phase difference between each cavity. The visibility V(t) measures the first-order phase coherence through the far-field optical interference contrast. The indistinguishability I(t) measures the identicality of the two photons emitted simultaneously from cavities number 1 and 3 through the Hong-Ou-Mandel interferometer. These quantities are graphed as a function of time in FIG. 4, where all the parameter settings are the same as in FIGS. 3A-D. As expected, I(t) rises to nearly 1 at 200 ps, corresponding to the generation of indistinguishable single photons. On the other hand, V(t) drops from 1 to 0.29 rather than 0 at the end. Note that the finite visibility implies a residual tunneling effect, which is a direct reflection of the non-unity η caused by the polariton loss through radiative decay before triggering the emissions of indistinguishable single photons. This is confirmed by artificially increasing Q and τ_{b} by an order of magnitude, and we find V(t) further drops to 0 while I(t) still rises to nearly 1.

### Experimental Considerations

Unlike ultracold atoms in an optical lattice where an extremely clean experimental environment can be prepared, disorder due to the fabrication error of solid-state devices is unavoidable. One important benefit of the device described above is its robustness against such an imperfection: first, the site energy disorder can be manually addressed and compensated by the QCSE, which alleviates the inhomogeneity seen by the LPs. Second, since the system is prepared initially in a SF state, the site energy disorder is effectively reduced by roughly a factor of d/J. In contrast to other deterministic generation schemes, such as photon blockade (PB) effect where the bandwidth of a pumped it pulse cannot spectrally well overlap the inhomogeneous LP site energies, the initialization of LP population in this technique is much more uniform. Note that the increase of a pumped π pulse bandwidth in the PB scheme to improve the spectral coupling is not allowed because a second LP is then excited and breaks down the PB principle. Based on these two benefits, the present technique can largely overcome the site energy disorder such as inhomogeneous broadening of cavity photons and QW excitons, and therefore provides a practical technique for massive parallel generation of indistinguishable single photons.

The operational temperature for the device will now be considered. To avoid particle-hole excitation in a MI state, a thermal energy KT should be much smaller than U. Supposing KT is an order of magnitude smaller than U, then T˜0.2 K is needed, which can be provided by a dilute refrigerator. Nevertheless, the device operation is based on a coherent spectroscopic technique and a serious thermalization effect kicks in only when the LPs are exciton-like, which lasts shorter than 100 ps during the device operation procedures (see FIGS. 3C-D). Such a number is smaller than the typical thermalization time in an exciton-polariton system at 4 K, and in this sense we may really probe the zero-temperature quantum dynamics shown above.

### Generation of Polarization-Entangled Photon Pairs

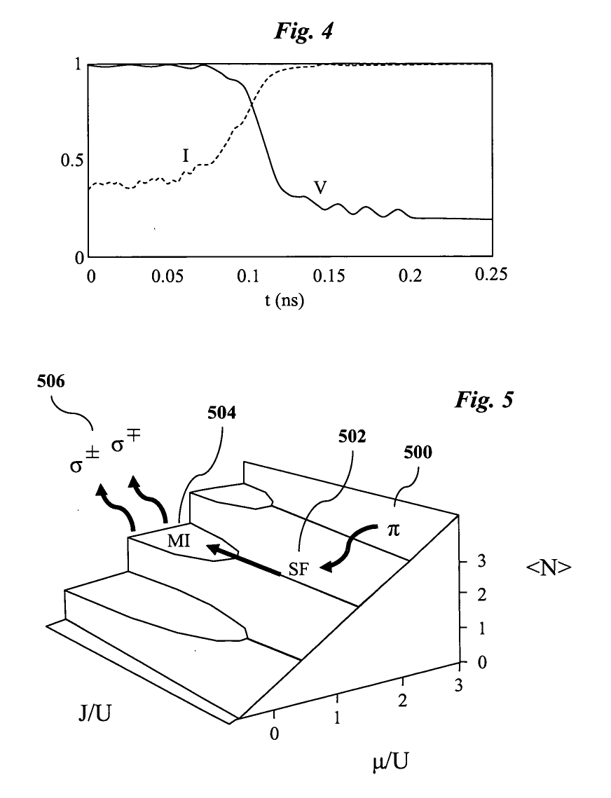

In another embodiment, the present invention provides techniques for generating polarization-entangled photon pairs. The discussion above neglected the spin of a LP by assuming that a circularly-polarized external laser is used for optical pumping. It is possible, however, to generate polarization-entangled photon pairs from the device via the QPT from a SF to MI state if the two spin species are simultaneously injected. This technique is illustrated in the phase diagram of FIG. 5. Initially, a linearly-polarized external laser injects on-average two LPs per cavity at a large J/U. This injection of equal populations of two spin species 500 forms a photon-like SF 502. Subsequent adiabatic 6 switching sweeps the system from SF state 502 into an exciton-like MI state 504 with two localized LPs in each cavity. The ground state of the proposed scenario is believed to be a collection of two opposite-spin LPs occupying the same site. This is due to fact that the electron (and hole) component of an exciton must satisfy the Pauli exclusion principle, so that the subsequent emissions are similar to the biexciton emissions in a semiconductor quantum dot. By using the selective switching as described earlier, a two-photon cascaded emission is triggered where the anticorrelation of LP spins is translated to the circularly-polarized states of photons. A maximally polarization-entangled photon pair 506 (|σ⁺>₁|σ⁻>₂+|σ⁻>₁|σ⁺>₂)/√2 is produced, where subscripts 1 and 2 refer to the first and second photon emitted that have an energy difference equal to U.

### Photonic Crystal Device

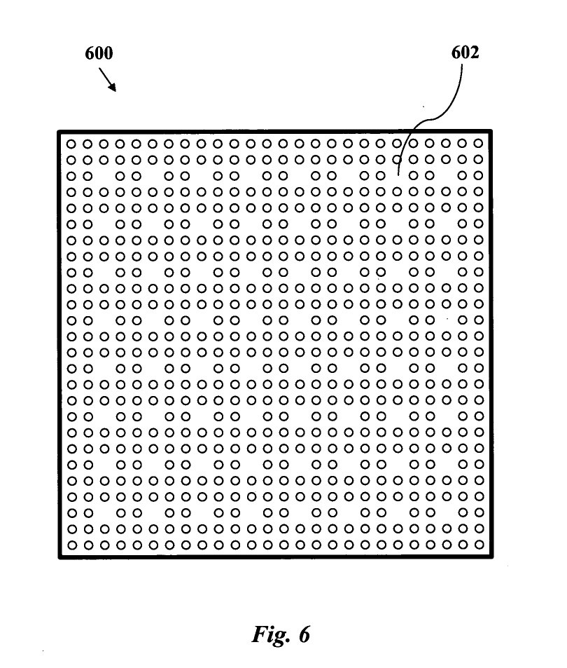

In another embodiment of the invention, the microcavity can be realized as a photonic crystal microcavity. The quantum phase transition from a SF to MI state can also be realized in coupled photonic crystal microcavities. FIG. 6, for example, is a schematic diagram of a photonic crystal microcavity 600 with a collection of traps, such as trap 602, created by “defects” in the lattice. A small photon mode volume and large exciton oscillator strength enable a large photon-exciton coupling constant. High Q value ensures a long polariton lifetime. Substitutional donor/acceptor impurities are used because of their highly homogeneous linewidth. Impurity bound excitons may be modeled as isolated two-level atoms. Such a photonic crystal microcavity may be implemented in a material system such as GaAs with Si impurities. The system may be initialized by resonant optical pumping. To create a polaritonic MI, the pump pulse bandwidth should be smaller than the interaction energy but larger than the radiative spectral linewidth to drive the filling factor from zero to one. Then, the injected polaritons require a short tunneling time compared with their radiative lifetime to reach an equilibrium state with negligible system-reservoir interaction. This is readily satisfied by demanding high Q, value.

### Summary of the Technique

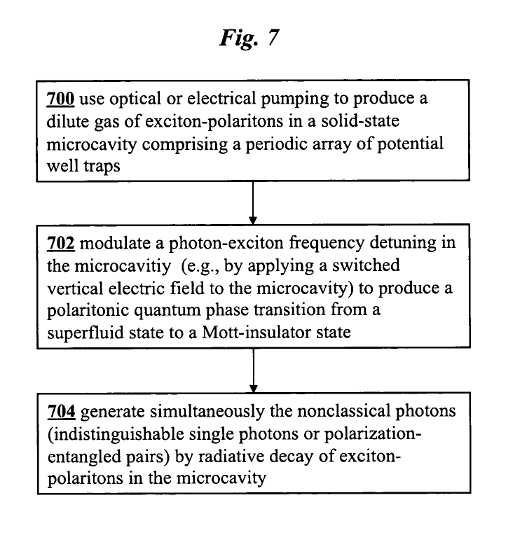

An outline of the main steps for generating nonclassical light according to the techniques of the present invention is shown in the flowchart of FIG. 7. In step 700, optical or electrical pumping is used to produce a dilute gas of exciton-polaritons in a solid-state microcavity comprising a periodic array of potential well traps. In step 702, a photon-exciton frequency detuning in the microcavity is modulated (e.g., by applying a switched vertical electric field to the microcavity) to produce a polaritonic quantum phase transition from a superfluid state to a Mott-insulator state. In step 704, the nonclassical photons (indistinguishable single photons or polarization-entangled pairs) are simultaneously generated by radiative decay of exciton-polaritons in the microcavity.

1. A method for deterministic generation of nonclassical photons, the method comprising:
producing a dilute gas of exciton-polaritons in a solid-state microcavity comprising a periodic array of potential well traps;
modulating a photon-exciton frequency detuning in the microcavity to produce a polaritonic quantum phase transition from a superfluid state to a Mott-insulator state;
generating simultaneously the nonclassical photons by radiative decay of exciton-polaritons in the microcavity.

2. The method of claim 1 wherein the generated nonclassical photons are indistinguishable single photons, and wherein the dilute gas of exciton-polaritons is produced such that on average there is one polariton per potential well trap.

3. The method of claim 1 wherein the generated nonclassical photons are polarization-entangled photon pairs, and wherein the dilute gas of exciton-polaritons is produced such that on average there are two polaritons per potential well trap.

4. The method of claim 1 wherein producing the dilute gas of exciton-polaritons comprises coupling the microcavity with an external laser pulse that has a predetermined amplitude and width.

5. The method of claim 1 wherein modulating the photon-exciton frequency detuning comprises applying a switched vertical electric field to the microcavity to perform an adiabatic quantum phase transition through the quantum-confined Stark effect.

6. The method of claim 1 wherein the microcavity is planar microcavity or a photonic crystal microcavity.

7. The method of claim 6 wherein the planar microcavity is realized as single or multiple quantum wells embedded in an optical cavity layer sandwiched between upper and lower distributed Bragg reflectors.

8. The method of claim 7 wherein the optical cavity layer is spatially modulated in thickness to produce photon traps.
